(19) United States
(12) Patent Application Publication
(10) Pub. No.: US 2020/0396745 A1
(43) Pub. Date: Dec. 17, 2020

(54) NETWORK MONITORING APPARATUS, TRANSMISSION APPARATUS, AND METHOD FOR NETWORK MONITORING

(71) Applicant: FUJITSU LIMITED, Kawasaki-shi (JP)

(72) Inventors: Claudia Khansa Atikah Hidayat, Kawasaki (JP); Hiroaki Komine, Yamato (JP)

(73) Assignee: FUJITSU LIMITED, Kawasaki-shi (JP)

(21) Appl. No.: 16/901,838

(22) Filed: Jun. 15, 2020

(30) Foreign Application Priority Data
Jun. 17, 2019 (JP) 2019-112195

(51) Int. Cl. H04W 72/08; H04L 12/26; H04L 29/06

(52) U.S. Cl. CPC H04W 72/085; H04L 69/22; H04L 43/08

(57) ABSTRACT

A network monitoring apparatus includes: a memory; and a processor coupled to the memory, the processor being configured to execute a grouping control processing that includes specifying, based on a slice/service type and priority information of a data flow, a group to which the data flow belongs, and allocating a same network slice to a plurality of data flows included in a same group, and execute a slice control processing that includes controlling an edge node of the network slice, based on grouping control information generated by the grouping control processing.

### CROSS-REFERENCE TO RELATED APPLICATION

This application is based upon and claims the benefit of priority of the prior Japanese Patent Application No. 2019412195, filed on Jun. 17, 2019, the entire contents of which are incorporated herein by reference.

### FIELD

The embodiment discussed herein is related to a network monitoring apparatus, a transmission apparatus, and a method for network monitoring.

### BACKGROUND

Currently, service for the fifth generation (5G) mobile communication system has been being provided. In a 5G network, compared to the fourth generation (4G) represented by long term evolution (LTE), Quality of Service (QoS) capability has been enhanced and new QoS parameters have been defined. In 5G transmission, highly-reliable and low-latency network service is expected in order to support technologies such as autonomous driving, remote control of drones and robots, and the Internet of Things (IoT).

Network slicing is among the key technologies in 5G. Network slicing is a technology with which a logical service network is extracted from one or more network resources, in accordance with a business entity or an application. Each extracted virtual network is called a “slice”.

For 5G, there has been assumed introduction of new service types such as “enhanced Mobile Broadband (eMBB)”, “Ultra-Reliable and Low Latency Communication (URLLC)”, and “Massive IoT (MIoT).” In the future, the number of slices for each of these service types is expected to increase rapidly.

For a network apparatus provided in a wireless access network, there has been proposed a configuration in which resources to be allocated to wireless terminals are managed every core network slice, on the basis of the service quality requirement and the function that a plurality of the core network slices each has.

There has been proposed a traffic flow allocation method in which each slice of a Software-Defined Network (SDN) shares one packet transfer queue, every physical link and shares a link band.

Examples of the related art include International Publication Pamphlet No. WO 2017/204067 and Japanese Laid-open Patent Publication No. 2015-177235.

### SUMMARY

According to an aspect of the embodiments, a network monitoring apparatus includes: a memory; and a processor coupled to the memory, the processor being configured to execute a grouping control processing that includes specifying, based on a slice/service type and priority information of a data flow, a group to which the data flow belongs, and allocating a same network slice to a plurality of data flows included in a same group, and execute a slice control processing that includes controlling an edge node of the network slice, based on grouping control information generated by the grouping control processing.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates general load control in network to hich network slicing is applied;

FIG. 2 illustrates lead control by a network monitoring apparatus of an embodiment;

FIG. 3 illustrates a system configuration of the embodiment;

FIG. 4 is a diagram illustrating an exemplary configuration of the network monitoring apparatus of the embodiment;

FIG. 5 is a table indicating an example of slice/service types;

FIG. 6 is a table indicating an example of service quality;

FIG. 7 illustrates an exemplary configuration of a transmission apparatus at a sender;

FIG. 8 illustrates an exemplary configuration of a transmission apparatus at a receiver;

FIG. 9 is a flowchart of header processing performed by the transmission apparatus at the sender;

FIG. 10 is a flowchart of header processing performed by the transmission apparatus at the receiver;

FIG. 11A illustrates an exemplary configuration of a header before trimming;

FIG. 11B illustrates an exemplary configuration of the header after trimming; and

FIG. 12 is a flowchart of a method for network monitoring performed by the network monitoring apparatus.

### DESCRIPTION OF EMBODIMENT(S)

Considering a significant number of information sources and a large amount of traffic, load on network management is likely to increase in a communication system to which network slicing is applied.

An object of an embodiment is to reduce load on network management in a communication system to which network slicing is applied.

Network load may be reduced.

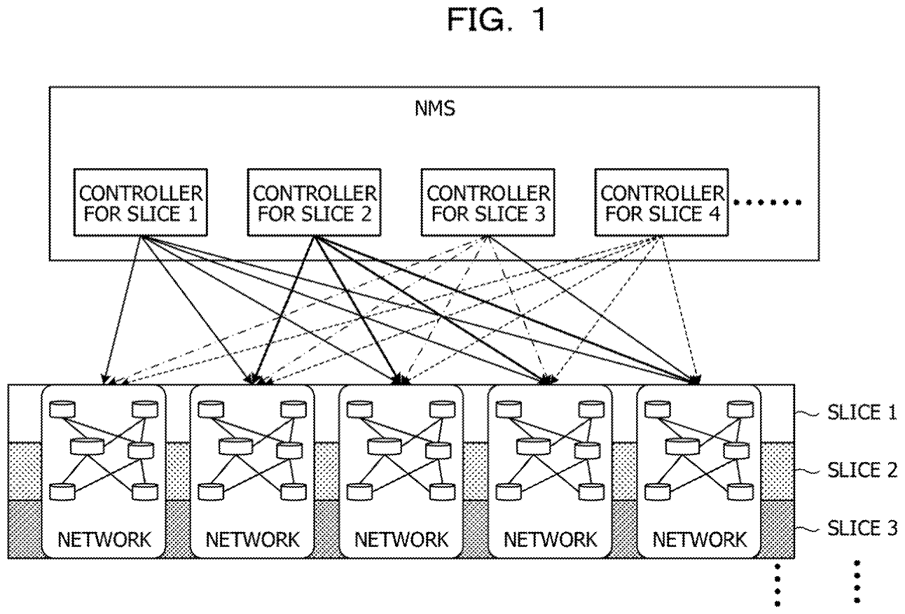

FIG. 1 illustrates general load control in transmission network to which network slicing is applied. Network resources such as a telecommunications carrier, a facility provider, and a service provider are virtually divided to form a virtual network (slice) corresponding to the application. For example, a slice 1 is used for high-speed and large-capacity communication, and a slice 2 is used for highly-reliable and low-latency service.

A network monitoring apparatus (in the figure, denoted as network management system (“NMS”) includes a slice controller that manages a data flow, every generated slice. Each slice controller controls and manages a network resource to be used for the slice, every network segment. Therefore, load on the network increases.

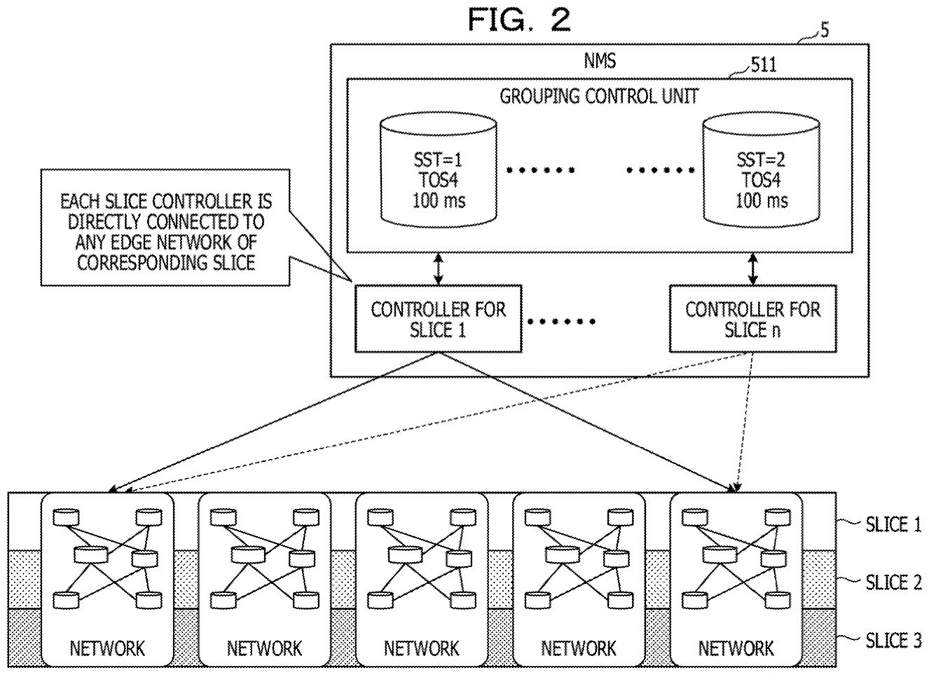

FIG. 2 illustrates load control by a network monitoring apparatus 5 of an embodiment. The network monitoring apparatus 5 includes a grouping control unit 511, and groups each data flow, on the basis of at least the slice/service type (SST) and the priority in service quality. Data flows each classified into the same group are placed on the same slice even in a case where the data flows are different in place of generation, timing of generation, destination, and the like.

For example, a data flow having an SST type of 1, a type of service (“TOS”) value of 4 indicating a priority level, and a latency budget of 100 ms is allocated to the slice 1 suitable for high speed and large capacity. Regardless of a terminal from which the data flow is sent, the slice 1 is used for a packet classified into the same group as the data flow.

A data flow having an SST type of 2, a TOS value of 4, and a latency budget of 100 ms is allocated to the slice 2 suitable for ultra-reliable and low-latency communication. Regardless of a terminal from which the data flow is sent, the slice 2 is used for a packet classified into the same group as the data flow.

This grouping control manages data flows that are the same in service type and priority, in the same slice. Thus, the number of slice controllers in the network monitoring apparatus 5 is reduced.

Each slice controller of the network monitoring apparatus 5 is directly connected to any edge network of the corresponding slice and controls the edge node. All network segments need not be controlled. Thus, load on the network control is reduced and the reduction provides smooth packet transmission in response to the desirable quality. Specific techniques and effects that achieve these operations will be described in detail below.

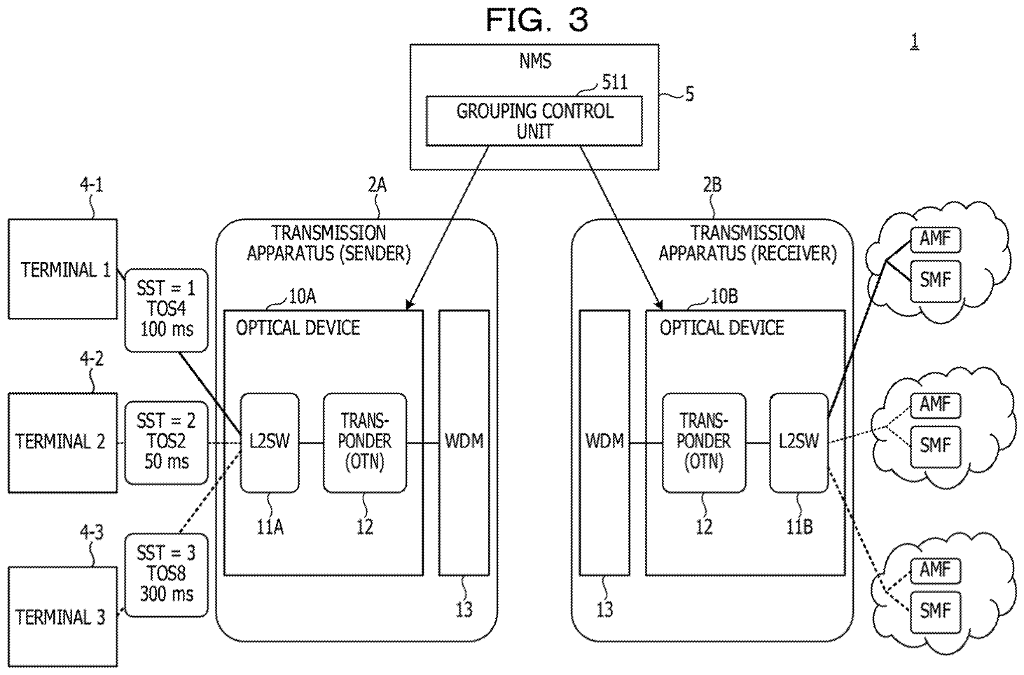

FIG. 3 illustrates a system configuration of the embodiment. A communication system 1 includes a transmission apparatus 2A at a sender, a transmission apparatus 26 at a receiver, and the network monitoring apparatus 5. The network monitoring apparatus 5 monitors and controls each of a wireless access network, an optical transport network, and a core network. Here, the description will be given, for example, focusing on monitoring of the optical transport network.

The network monitoring apparatus 5 monitors state and performance of the network, a data flow that passes through the network, an occurrence of failure, and the like, controls the transmission apparatuses 2A and 26, and maintains quality of the network.

The transmission apparatus 2A and the transmission apparatus 2B are located at an edge of a virtual network slice. The transmission apparatus 2A and the transmission apparatus 28 located at the edge may change depending on a network slice to be used. For simplicity of illustration and description, the configuration at the sender is illustrated for the transmission apparatus 2A and the configuration at the receiver is illustrated for the transmission apparatus 26. In fact, however, the transmission apparatus 2A and the transmission apparatus 26 each have a transmission and reception function, and are capable of bidirectional communication.

Each of terminals 4-1, 4-2, and 4-3 (hereinafter, collectively referred to as “terminal 4” as appropriate) sends a packet. The terminal 4 is a device on the client side, and may be a user terminal or a server of a provider. Request conditions of the packets that are sent from each terminal 4 may not be the same and desirable communication conditions often differ depending on purpose and application. Furthermore, a packet having a different request condition may be sent from the same terminal 4.

In the example of FIG. 3, the terminal 4-1 sends a packet having an SST type of 1, a TOS value of 4, and a latency budget of 100 ms. The terminal 4-2 sends a packet having an SST type of 2, a TOS value of 82, and a latency budget of 50 ms. The terminal 4-3 sends a packet having an SST type of 3, a TOS value of 8, and a latency budget of 300 ms.

The network monitoring apparatus 5 monitors generated data flows, groups each data flow, on the basis of at least the SST and the priority information, and allocates a suitable network slice (hereinafter, abbreviated as a “slice”) every group. Each slice is a logical network virtually formed by using at least part of resources of one or more networks. The network monitoring apparatus 5 controls the transmission apparatus 2A and the transmission apparatus 26 located at the edge of the slice, and reduces load on the entire network as described below.

The transmission apparatus 2A includes an optical device 10A and a wavelength division multiplexing (WDM) device 13. The optical device 10A includes a layer 2 (L2) switch 11A and a transponder 12. The L2 switch 11A judges a relay destination from a media access control (MAC) address included in each packet, and outputs, for example, a signal of 10 Gbps.

When relaying the packet, the L2 switch 11A performs processing on the packet, on the basis of grouping control information from the network monitoring apparatus 5. In accordance with the slice/service type and priority of the packet, the L2 switch 11A performs processing of, for example, reducing the header of the packet or adding a parameter indicating the priority. These pieces of processing will be described below.

The transponder 12 converts a frame format of the client-side network into an optical transport network (OTN) standard format, and converts the converted format into an optical signal at a specific wavelength (for example, λ1) for wavelength multiplexing. The WDM device 13 multiplexes optical signals at a plurality of wavelengths generated by a plurality of transponders, and outputs the multiplexed optical signals to an optical transmission line.

The transmission apparatus 26 includes a WDM device 13 and an optical device 106. The transmission apparatus 26 performs processing in a direction opposite to the processing by the transmission apparatus 2A. The optical device 106 includes a transponder 12 and a L2 switch 116, as an example. The WDM device 13 demultipiexes, every wavelength, the wavelength multiplexed signals received through the optical transmission line, and outputs the optical signals at the individual wavelengths to the transponder 12. The transponder 12 converts each optical signal converted into the OTN format, into a signal format of the client-side network, and outputs the signal format to the L2 switch 11B.

The L2 switch 116 transfers each packet to a network of a transfer destination. At this time, on the basis of the grouping control information acquired from the network monitoring apparatus 5, the L2 switch 116 recovers trimmed information of each packet or removes an inserted priority-type parameter, and then outputs the packet to the transfer destination.

In each network of the transfer destination, session management is performed every slice by a session management function (SMF). Mobility management may be performed centrally by an access and mobility management function (AMF).

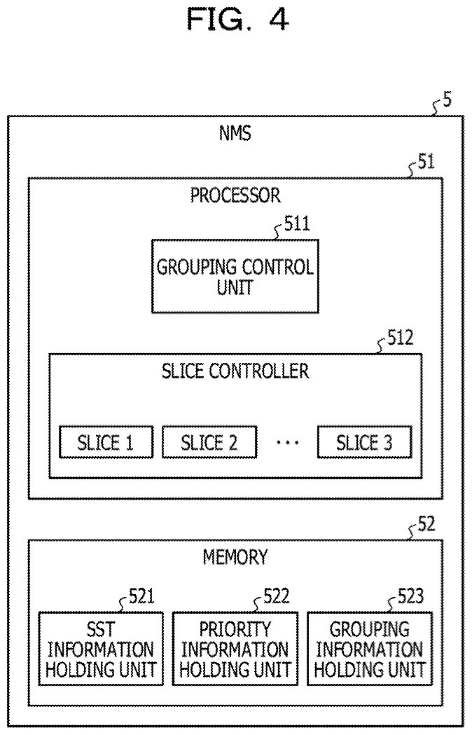

FIG. 4 is a diagram illustrating an exemplary configuration of the network monitoring apparatus 5. The network monitoring apparatus 5 includes at least a processor 51 and a memory 52 as hardware resources. The memory 52 includes a main storage device and an auxiliary storage device.

As a functional configuration, the network monitoring apparatus 5 includes a grouping control unit 511, a slice controller 512, an SST information holding unit 521, a priority information holding unit 522, and a grouping information holding unit 523.

The grouping control unit 511 determines to which group a data flow belongs, on the basis of the slice/service type (SST) and priority of each data flow. The determination result is reported, as grouping control information, to the transmission apparatus 2A and the transmission apparatus 2B located at the edge of the slice. The grouping control information is, for example, a value indicating a group ID or a slice ID, and has a small number of bits. As the grouping control information, a virtual local area network-ID (ULAN-ID) for identifying a virtual L2 segment may be used.

The slice controller 512 manages the data flows, every slice. In the embodiment, all data flows that are the same in service type priority are managed in the same slice. Thus, the number of slices to be managed is smaller than the number of slices in the configuration of FIG. 1. Moreover, the control information of each slice is directly reported only to a node located at the edge of the slice. Thus, network load for the slice management is small.

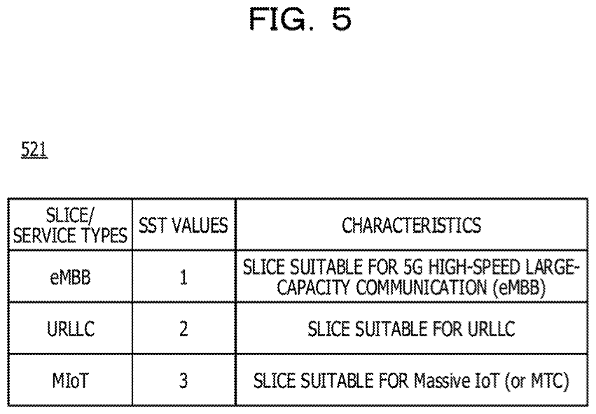

FIG. 5 is an example of SST information held by the SST information holding unit 521. An SST value is given to each slice/service type such as enhanced Mobile Broadband (eMBB), Ultra-Reliable and Low Latency Communication (URLLC), and Massive Internet of Things (Mior). The eMBB is slice suitable for large-capacity high-speed communication that uses a wide band. For example, the eMBB is used when a smartphone or the like receives a high-definition video image by streaming.

The URLLC is used for autonomous driving control and traffic control that need high reliability in real time. The MIoT is used when a large number of devices transmit and receive data simultaneously such as communication between transportation infrastructure and each vehicle, and a wide area sensor network, although the amount of each individual piece of data is small.

The grouping control unit 511 specifies an SST type, every generation of a data flow. The SST type is not limited to the above, and may be used as the basis for grouping even when a new SST is provided in the future.

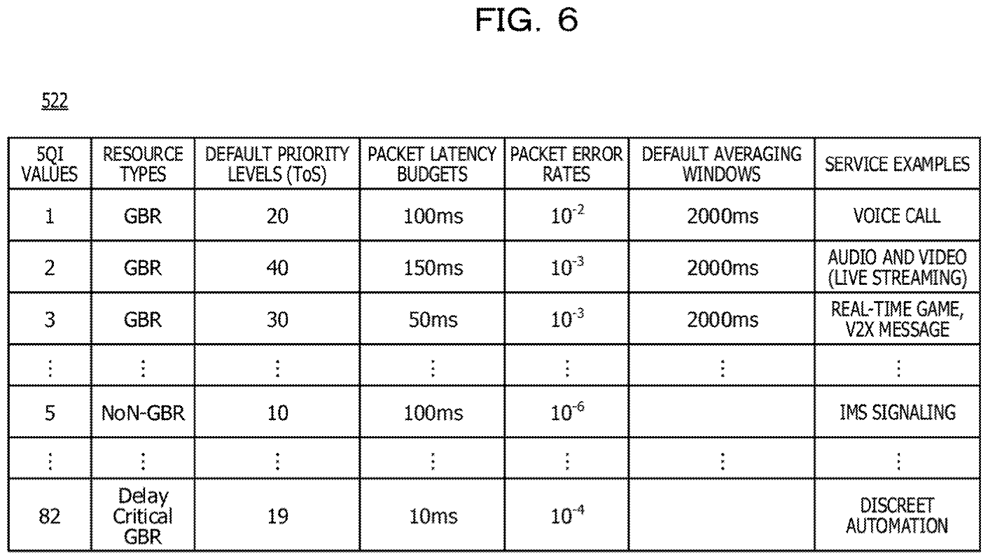

FIG. 6 is an example of priority information held by the priority information holding unit 522. A resource type, a default priority level (TOS value), a packet latency budget, a packet error rate, an averaging window, and the like are defined every 5G Quality of Service (QoS) indicator (5QI).

The resource types include a guaranteed Bit Rate (GBR) that is guaranteed in band, a non-GBR that is not guaranteed in band, and a delay critical GBR.

For the QoS indicator (5QI) and the priority level (TOS), a smaller value has a higher priority. As the packet latency budget is smaller, the allowable latency time is shorter. As the packet error rate is smaller, higher reception quality is desirable. Although IP multimedia subsystem (IMS) signaling for network control is not guaranteed in band, the priority level is very high.

Every generation of a data flow, the grouping control unit 511 refers to the priority information and specifies the priority of the data flow. The priority may be judged primarily on the basis of the TOS value. Different information such as the 5QI value, the resource type, and the latency budget may be used instead of or together with the TOS value.

Grouping information held by the grouping information holding unit 523 is associated with the corresponding slice ID or group ID, every combination of the SST value and the priority information, for example. Even for data flows sent from different information sources, when the group decided by the SST and the priority information is the same, the data flows are allocated to the same slice.

At least part of the grouping information generated by the network monitoring apparatus 5 may be reported, as the grouping control information, to the transmission apparatuses 2A and 2B. Such grouping control information may include identification information uniquely given to each data flow by the network,

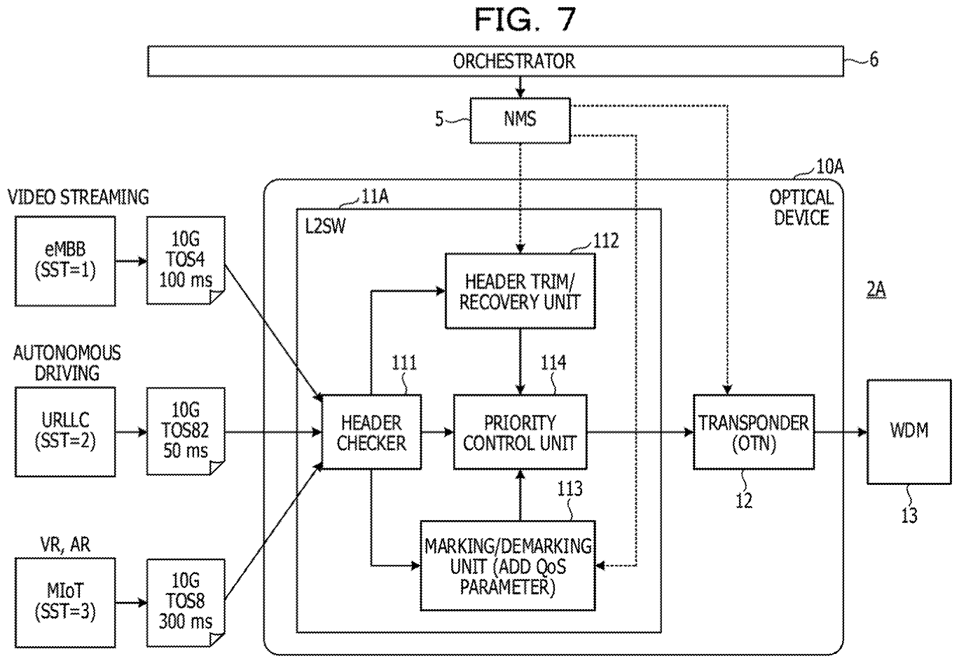

FIG. 7 illustrates an exemplary configuration of the transmission apparatus 2A at the sender. The L2 switch 11A of the transmission apparatus 2A includes a header checker 111, a header trim/recovery unit 112, a marking/demarking unit 113, and a priority control unit 114. The header trim/recovery unit 112 and the marking/demarking unit 113 are examples of a header processing unit. The L2 switch 11A may be achieved with a network processor, an application specified integrated circuit (ASIC), a field programmable gate array (FPGA), or a different logic circuit.

The header checker 111 checks the header of each packet received from the client side. For example, a video stream having a service type of eMBB (SST value of 1), a control signal for autonomous driving having a service type of URLLC (SST value of 2), content data having a service type of MIoT (SST value of 3), and the like are input into the transmission apparatus 2A.

The header checker 111 judges a transfer destination from the header of each packet. Furthermore, in accordance with the priority information of each packet, the header checker 111 distributes the packet to the header trim/recovery unit 112 and the marking/demarking unit 113. As described above, the priority information includes the priority level (TOS value), the 5QI value, the latency budget, the resource type, and the like.

For a packet with a requirement relatively loose in latency and reliability, the header is trimmed to reduce network load. For a packet with a requirement strict in latency and reliability, a QoS parameter is added.

The header trim/recovery unit 112 trims the header of a packet that is supplied from the header checker 111, generates a new header, and reduces the packet size. The marking/demarking unit 113 adds a QoS parameter to the header of a packet that is supplied from the header checker 111.

Each packet with the header processed is output to the transponder 12 in accordance with a priority order decided by the priority control unit 114. Each packet is converted into an optical signal at a predetermined wavelength by the transponder 12. Subsequently, the packet is multiplexed with an optical signal at different wavelength by the WDM device 13, and output to the optical transport network.

The L2 switch 11A and the transponder 12 are monitored by the network monitoring apparatus 5. The network monitoring apparatus 5 is under the control by an orchestrator 6, which is a higher-level apparatus. The orchestrator 6 manages and integrates virtualization of network functions.

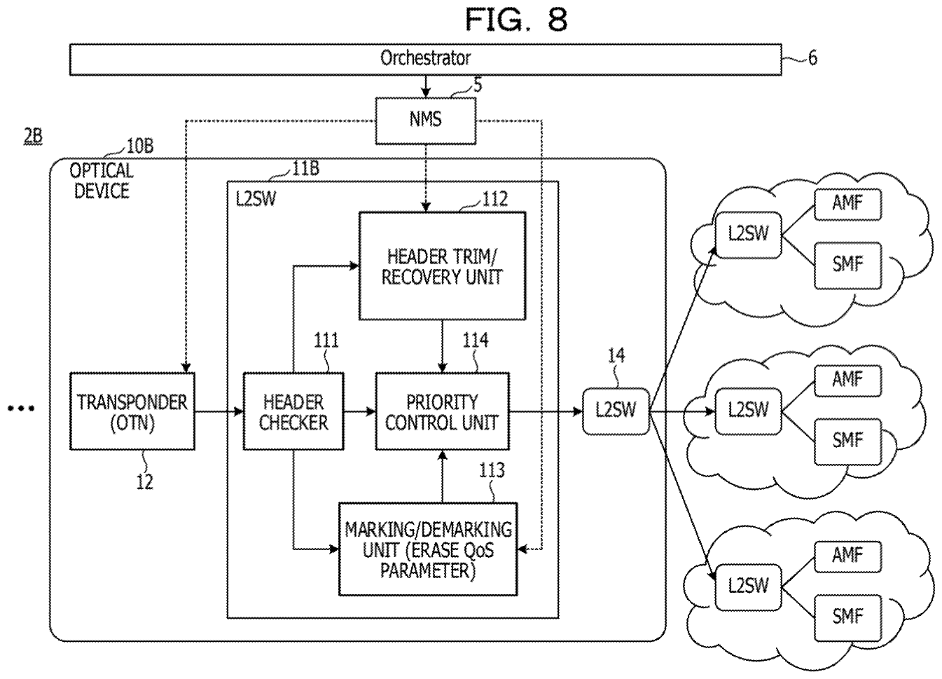

FIG. 8 illustrates an exemplary configuration of the transmission apparatus 2B at the receiver. The L2 switch 11B of the transmission apparatus 2B includes a header checker 111, a header trim/recovery unit 112, a marking/demarking unit 113, and a priority control unit 114. The header trim/recovery unit 112 and the marking/demarking unit 113 are examples of a header processing unit. The L2 switch 11B may be achieved with a network processor, an ASIC, an FPGA, or a different logic circuit.

The header checker 111 checks the header of the packet converted, by the transponder 12, into the electric signal in the client-side format. For the packet with the header trimmed and reduced, the header checker 111 distributes the packet to the header trim/recovery unit 112. For the packet with the header to which the QoS parameter is added, the header checker 111 distributes the packet to the marking/demarking unit 113.

The header trim/recovery unit 112 uses an IP address or the like included in the grouping control information reported from the network monitoring apparatus 5, and recovers the original header. The marking/demarking unit 113 erases the QoS parameter.

The packet with the header processed is output in accordance with an order decided by the priority control unit 114, and sent to a network of a transfer destination by an L2 switch 14 on the client side.

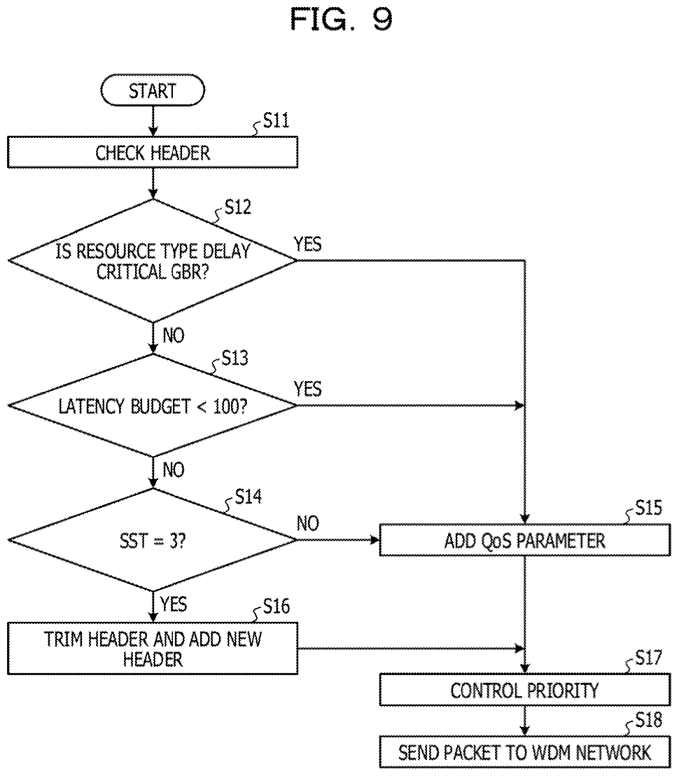

FIG. 9 is a flowchart of header processing performed by the L2 switch 11A of the transmission apparatus 2A at the sender. The L2 switch 11A checks the header of each packet and specifies a transfer destination (S11), and determines the priority of the packet. The priority may be determined by using grouping control information reported from the network monitoring apparatus 5. As an example, the L2 switch 11A judges whether the resource type is a delay critical GBR (S12). When the resource type is the delay critical GBR (YES in S12), the packet has a requirement strict in latency. Thus, the L2 switch 11A adds a QoS parameter indicating the priority, without reducing the header (S15). As the QoS parameter, for example, a 5QI value or a TOS value may be used.

When the resource type is not the delay critical GBR (NO in S12), which is, for example, when the resource type is a GBR that is guaranteed in band or a non-GBR that is not guaranteed in band, the L2 switch 11A judges whether the latency budget is smaller than 100 ms (S13). When the latency budget is smaller than 100 ms (YES in S13), the allowable latency time is short. Thus, the L2 switch 11A adds the QoS parameter without reducing the header (S15).

When the latency budget is 100 ms or larger (NO in S13), the L2 switch 11A judges whether the SST value is 3, which is, for example, whether the service type is the MIoT (S14). When the SST value is 3 (YES in S14), the packet has a requirement that is not so strict in latency as compared with the different service types. Thus, the L2 switch HA trims the header and adds a new header (516). For the MIoT, a large number of packets are sent simultaneously although the individual packets are small in size. Thus, a certain amount of bandwidth is desirable as a whole. Reduction in header size reduces bandwidth allocated to individual packets and improves overall band efficiency.

When the SST value is not 3 (NO in S14), high-speed and large-capacity communication or ultra-reliable and low-latency communication is requested. Thus, the L2 switch 11A adds the QoS parameter without reducing the header (515). The QoS parameter may be used for subsequent priority order control.

After these pieces of header processing, the priority order is controlled (517), and then the packet is sent to a WDM network (518).

In the example of FIG. 9, the resource type, the latency budget, and the SST are used as the basis of the determination in the header processing. However, threshold judgement may be performed by using, for example, the 5QI value, the TOS value, and the security level. The order of the judgement is not limited to the example of FIG. 9, and thus the judgement in S12 to S14 may be performed in any order.

The SST, the priority, and the like may be determined by the network monitoring apparatus 5, instead of being determined by the L2 switch 11A on the basis of the grouping control information reported from the network monitoring apparatus 5. In this case, the network monitoring apparatus 5 judges whether the header is trimmable and a QoS parameter value to be added. After the judgement, the network monitoring apparatus 5 instructs the L2 switch 11A to trim the header or add the QoS parameter. The L2 switch 11A performs the header processing following the instruction.

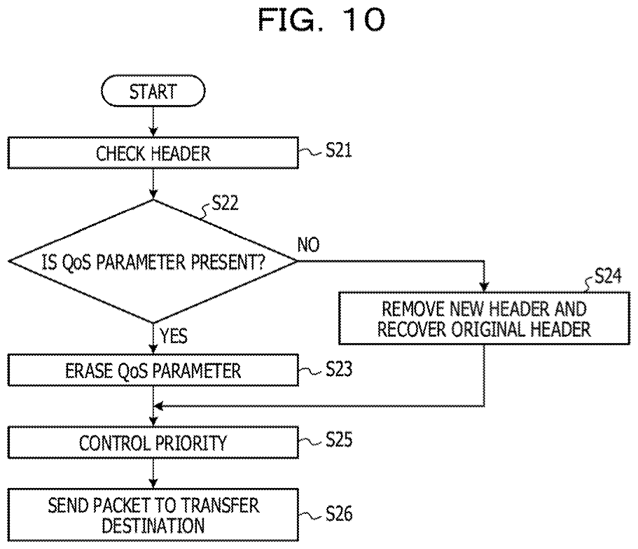

FIG. 10 is a flowchart of header processing performed by the L2 switch 116 of the transmission apparatus 26 at the receiver. The L2 switch 116 checks the header of each packet (S21) and judges whether the QoS parameter has been added (S22). When the QoS parameter is present (YES in S22), the L2 switch 116 erases the QoS parameter (S23). When no QoS parameter is present (NO in S22), the L2 switch 11B removes the new header, and recovers the original header including the IP addresses of the sending source and the destination (S24).

The priority order for the packet with the header processed is judged (S25), and the packet is sent to the transfer destination in accordance with the priority order (S26).

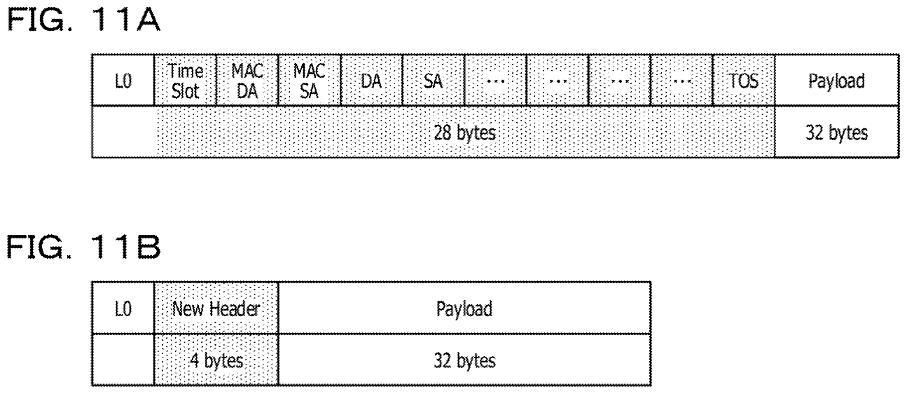

FIG. 11A illustrates a packet format before a header is trimmed, and FIG. 11B illustrates the packet format after the header is trimmed. In FIG. 11A, before trimming, a 28-byte header is added to a 32-byte payload. The header describes a wavelength information LO, the MAC address (MAC SA) of the sending source, the MAC address (MAC DA) of the destination, the IP addresses of the sending source and the destination, the TOS, and the like.

In FIG. 11B, the header portion other than the wavelength information L is trimmed and a new 4-byte header is added. This new header includes, for example, identification information uniquely given by the network.

Compared with the size of the packet before trimming, the size of the packet after trimming is reduced to 36/60, which is, for example, 60%, and the bandwidth per packet may be reduced to 3/5. Use efficiency in bandwidth may be improved by about 1.7 times (100/60).

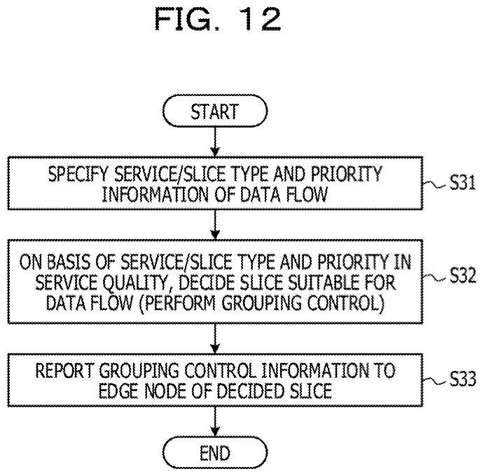

FIG. 12 is a flowchart of a method for network monitoring performed by the network monitoring apparatus 5. The network monitoring apparatus 5 specifies an SST and priority information, every data flow (S31). The SST is a service type such as eMBB, URLLC, and MIoT. The priority information is, for example, a 5G QoS characteristic value mapped to a standard 5QI value.

The network monitoring apparatus 5 performs grouping control to decide a slice suitable for the data flow, on the basis of the SST and the priority in service quality (S32). Therefore, a data flow having the same SST and priority is transmitted by using the same slice regardless of the information source.

The network monitoring apparatus 5 reports the grouping control information to the edge node of the decided slice (S33). The grouping control information includes the SST and the priority information of the data flow. Together with these pieces of information, whether the header is trimmable or a QoS parameter to be added may be reported.

This method enables reduction in load on the optical transport network and improvement in band use efficiency.

As described above, the embodiment has been described on the basis of the specific configuration examples. The present embodiment, however, is not limited to the embodiment described above. For example, priority information that is used when a data flow is grouped is not limited to the TOS value and the latency budget, and thus the resource type, the QoS value, the packet error rate, or the like may be used. A parameter that is used to judge whether the header is trimmable is not limited to the resource type, the latency budget, or the SST value, and thus the TOS value or the QoS value may be used. In each case, load on an optical transport network may be reduced while maintaining requirements in latency and reliability. Furthermore, reduction in header size of an MIoT packet enables improvement in band use efficiency.

In the embodiment, the packet header processing is performed by the L2 switch, but may be performed by a different relay device.

The configuration and technique of the embodiment are not limited to a standardized 5G network, and are applicable to any network in which a data flow having a different request condition is generated and network virtualization is applied.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A network monitoring apparatus comprising:
a memory; and
a processor coupled to the memory, the processor being configured to
execute a grouping control processing that includes
specifying, based on a slice/service type and priority information of a data flow, a group to which the data flow belongs, and
allocating a same network slice to a plurality of data flows included in a same group, and
execute a slice control processing that includes controlling an edge node of the network slice, based on grouping control information generated by the grouping control processing.

2. The network monitoring apparatus according to claim 1,
wherein the slice control processing is configured to report, to the edge node, at least part of the grouping control information regarding the network slice.

3. A transmission apparatus comprising:
a memory; and
a processor coupled to the memory, the processor being configured to
execute a header check processing that includes specifying a transfer destination from a header of a packet that is input, and
execute a header processing that includes performing, based on control information supplied from a network monitoring apparatus, reducing of a size of the header or adding of priority information to the header.

4. The transmission apparatus according to claim 3,
wherein the header processing is configured to reduce the size of the header, when a latency request of the packet indicated by the control information is lower than a predetermined level.

5. A transmission apparatus comprising:
a memory;
a processor coupled to the memory, the processor being configured to
execute a header check processing that includes
checking a header of a packet that is input, and
specifying a transfer destination, and
execute a header processing that includes controlling recovering processing in accordance with a size of the header or in accordance with presence or absence of priority information that is added to the header, the recovering processing being configured to recover an original header, based on control information supplied from a network monitoring apparatus.

6. The transmission apparatus according to claim 5,
wherein the controlling of the recovering processing is configured to perform the recovering processing when the size of the header is smaller than a predetermined value, the recovering processing being configured to remove the header and add original header information indicated by the control information.

7. A method for network monitoring, the method comprising;
specifying, by a network monitoring apparatus, based on a slice/service type and priority information of a data flow, a group to which the data flow belongs;
allocating, by the network monitoring apparatus, a same network slice to a plurality of data flows included in a same group; and
controlling an edge node of the network slice, based on grouping control information generated by the network monitoring apparatus.

8. The method according to claim 7, further comprising:
performing, by a first edge node of the network slice based on at leas part of the grouping control information, reducing of a size of a header of a packet included in the data flow or adding of the priority information to the header.

9. The method according to claim 8, further comprising:
recovering, by a second edge node of the network slice, a pre-processing header, based on the at least part of the grouping control information.
